(19) United States
(12) Patent Application Publication
(10) Pub. No.: US 2021/0330101 A1
(43) Pub. Date: Oct. 28, 2021

(54) PILLOW APPARATUS AND METHOD

(71) Applicant: Lauren Tencza, Edison, NJ (US)

(72) Inventor: Lauren Tencza, Edison, NJ (US)

(21) Appl. No.: 16/858,039

(22) Filed: Apr. 24, 2020

(51) Int. Cl. A47G 9/10; G06F 1/16

(52) U.S. Cl. CPC A47G 9/10; G06F 1/1628

(57) ABSTRACT

An apparatus including a pillow apparatus comprising first and second portions which are attached together. The first portion may include a cushion; and the second portion may be elastic. The second portion may be attached to the first portion so that a pocket is formed between the two portions. The pillow apparatus may be configured to securely encapsulate a laptop or tablet computer of a first size within the pocket. The pillow apparatus may be configured to securely encapsulate a laptop or tablet computer of a second size larger than the first size within the pocket. The pocket is configured to expand so that the pocket is larger when the laptop or tablet computer of the second size is within the pocket than when the laptop or tablet computer of the first size is within the pocket. The second portion may be substantially thinner than the first portion.

### FIELD OF THE INVENTION

This invention relates to pillows.

### BACKGROUND OF THE INVENTION

Various pillow devices are known in the art.

### SUMMARY OF THE INVENTION

In at least one embodiment, an apparatus is provided which includes a pillow apparatus comprising a first portion; and a second portion attached to the first portion.

The first portion may include a cushion; and the second portion may be elastic. The second portion may be attached to the first portion so that a pocket is formed between the first portion and the second portion.

In at least one embodiment, the pillow apparatus may be configured to securely encapsulate a laptop computer or tablet computer of a first size within the pocket. The pillow apparatus may be configured to securely encapsulate a laptop computer or tablet computer of a second size larger than the first size within the pocket.

In at least one embodiment, the pocket is configured to expand so that the pocket is larger when the laptop computer or tablet computer of the second size is within the pocket than when the laptop of the first size is within the pocket.

The second portion may be substantially thinner than the first portion. The first portion may be at least ten times thicker than the second portion. The second portion may be made entirely of one or more of rayon, nylon, and spandex.

The apparatus may further include the laptop computer or tablet computer of the first size, and the laptop computer or tablet computer of the second size. The first portion may have a surface with personalized indicia on it.

In at least one embodiment, a method is provided which includes inserting a laptop computer or tablet computer of a first size into a pocket of a pillow apparatus, so that the laptop computer or tablet computer of a first size is securely encapsulated within the pocket, and wherein the pillow apparatus may be configured as previously described.

The method may further include taking the laptop computer or tablet computer of the first size out of the pocket; and inserting a laptop computer or tablet computer of a second size into the pocket, wherein the second size is larger than the first size; and wherein the pillow apparatus is configured to securely encapsulate the laptop computer or tablet computer of the second size within the pocket. The method may further include placing personalized indicia on a top surface of the first portion.

### BRIEF DESCRIPTION OF THE DRAWINGS

FIG. 1 is a front, top, and left side perspective view of part of a pillow apparatus, with a closed laptop computer or tablet computer shown in broken lines being held inside of the pillow apparatus, in accordance with an embodiment of the present invention;

FIG. 2 is a front elevational view of the pillow apparatus of FIG. 1, with the closed laptop computer or tablet computer shown in broken lines being held inside of the pillow apparatus;

FIG. 3 is a rear elevational view of the pillow apparatus of FIG. 1;

FIG. 4 is a left side elevational view of the pillow apparatus of FIG. 1;

FIG. 5 is a right side elevational view of the pillow apparatus of FIG. 1;

FIG. 6 is a top elevational view of the pillow apparatus of FIG. 1, with part of the closed laptop computer or tablet computer shown in broken lines;

FIG. 7 is a bottom elevational view of the pillow apparatus of FIG. 1;

FIG. 8 is a front, top, and left side perspective view of part of another pillow apparatus in accordance with another embodiment of the present invention, with a closed laptop computer or tablet computer shown in broken lines being held inside of the pillow apparatus; and

FIG. 9 is a bottom elevational view of the pillow apparatus of FIG. 8.

### DETAILED DESCRIPTION OF THE DRAWINGS

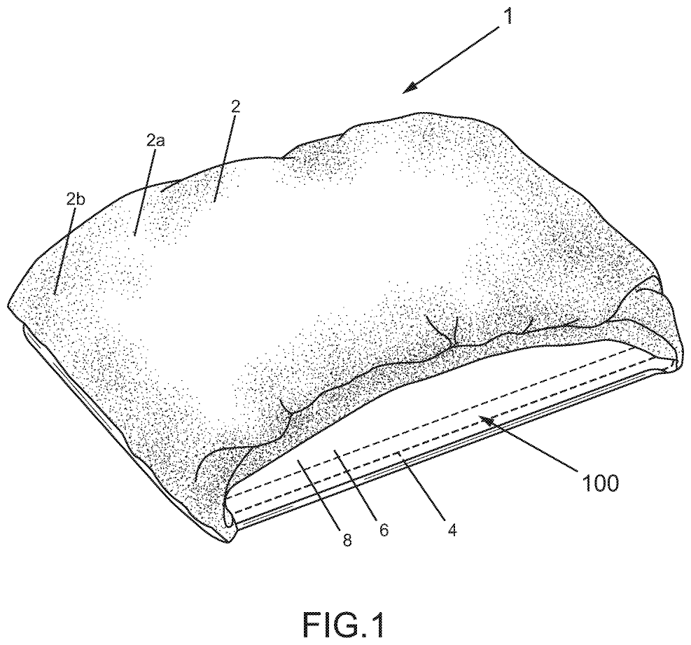

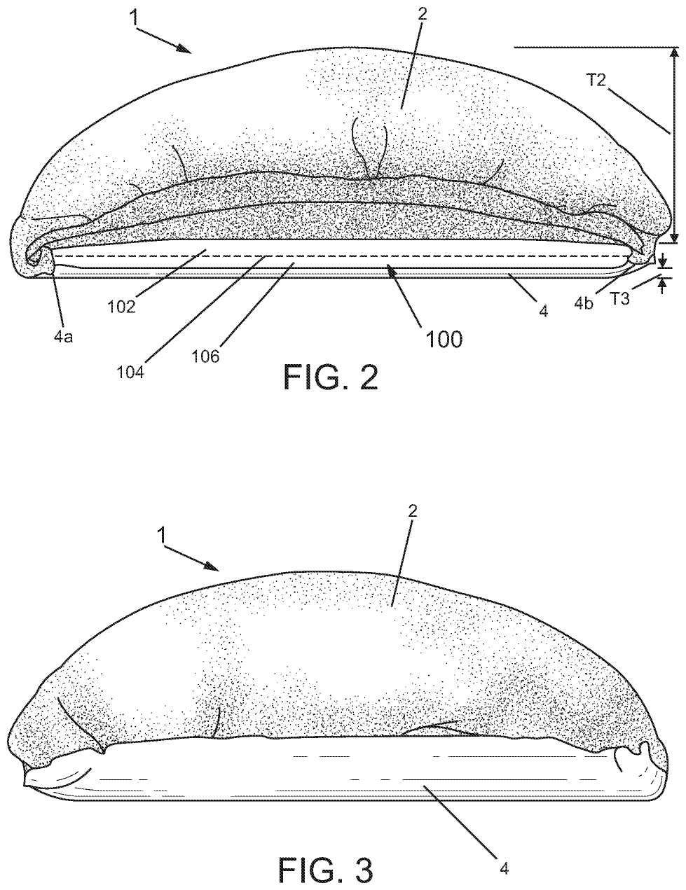

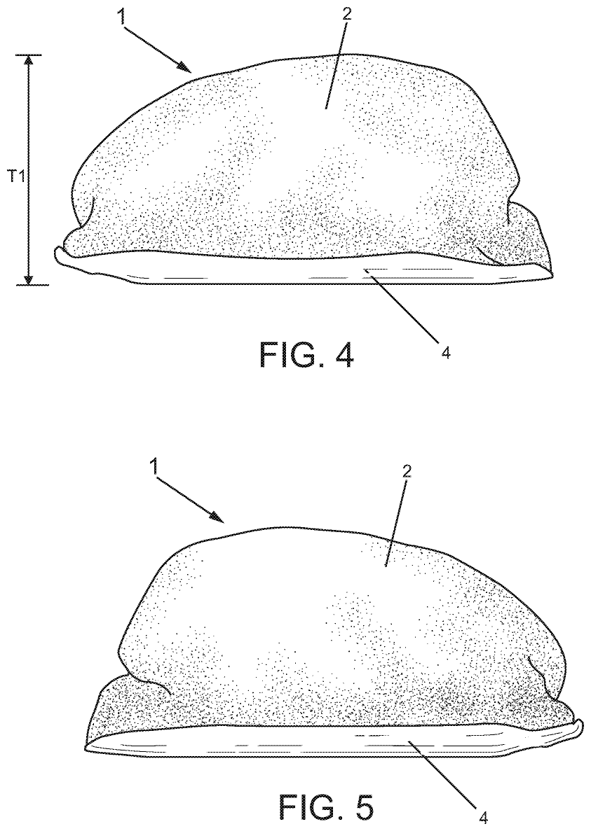

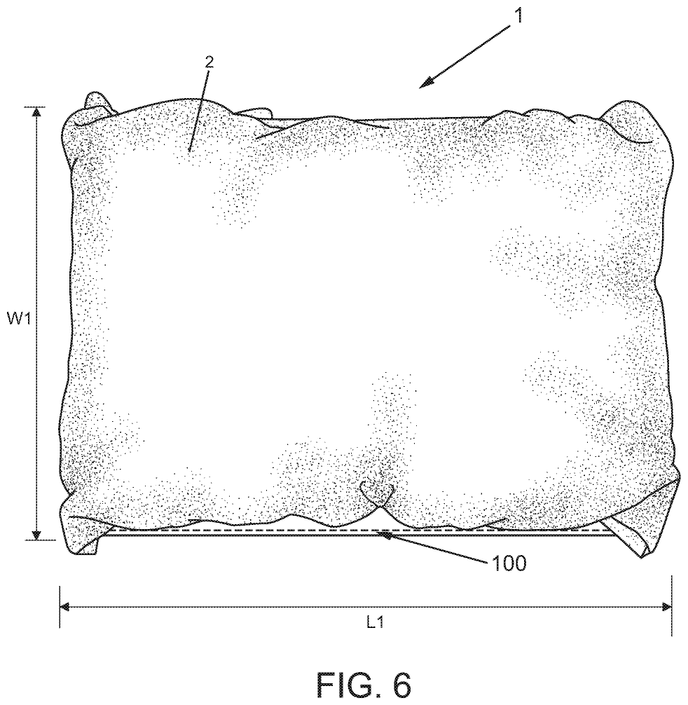

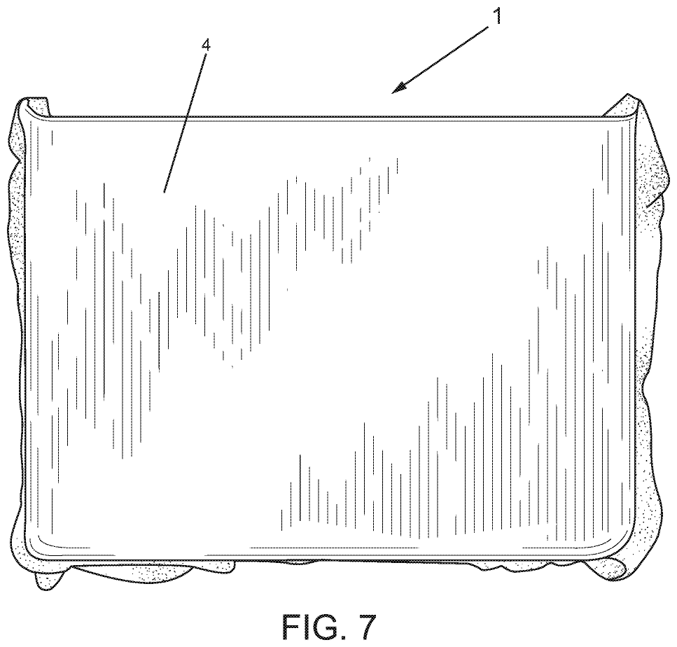

FIG. 1 is a front, top, and left side perspective view of part of a pillow apparatus 1, with a closed laptop computer or tablet computer 100 shown in broken lines being held inside of the pillow apparatus 1, in accordance with an embodiment of the present invention. FIG. 2 is a front elevational view of the pillow apparatus 1 of FIG. 1, with the closed laptop computer or tablet computer 100 shown in broken lines being held inside of the pillow apparatus 1. FIG. 3 is a rear elevational view of the pillow apparatus 1 of FIG. 1. FIG. 4 is a left side elevational view of the pillow apparatus 1 of FIG. 1. FIG. 5 is a right side elevational view of the pillow apparatus 1 of FIG. 1. FIG. 6 is a top elevational view of the pillow apparatus 1 of FIG. 1, with part of the closed laptop computer or tablet computer 100 shown in broken lines. FIG. 7 is a bottom elevational view of the pillow apparatus 1 of FIG. 1.

Referring to FIGS. 1-7, the pillow apparatus 1 includes a top section or portion 2 and a bottom section or portion 4. The top section or portion 2 includes a material 2a which typically completely encloses an inner material 2b. The inner material 2b may be a cushion such as used for a typical known pillow. The material 2a may be an outer covering or enclosure such as used for a typical known pillow. The inner material or cushion 2b, would typically be covered by the material 2a so that the inner material or cushion would not be visible in FIG. 1. However, the material 2b would be visible if the material 2a is transparent.

In at least one embodiment of the present invention, it is critical that the bottom section or portion 4 be made entirely or substantially of an expandable, elastic material. An expandable, elastic material for the portion 4 allows laptop computer or tablet computers of different sizes to be inserted through an opening 6 of the pillow apparatus 1, and into an inner chamber 8 of the pillow apparatus 1, and to be held securely in the inner chamber or pocket 8 by the portion 2 and the portion 4, and in between the portion 2 and the portion 4. It is critical, in at least one embodiment that the portion 4 be made of expandable, elastic materials to allow for insertion of different size laptop computers or tablet computers. The portion 4 may made of, for example, a mixture of nylon, spandex, and rayon, or only two of the materials nylon, spandex and rayon. For example, the portion 4 may be made of a combination of 80% nylon and 20% spandex or a combination of 47% rayon, 43% nylon, and 10% spandex.

It is critical in at least one embodiment, that the portion 4 be fixed to the portion 2 along junction lines 4a and 4b, shown in FIG. 2. The portion 4 may be fixed to the portion 2 along lines 4a and 4b by sewing or in some other manner.

As shown in FIG. 6, the pillow apparatus 1 may have a width W1 which may be about eleven inches and a length L1 which may be about fourteen inches. These dimensions are critical in at least one embodiment, to accommodate a specific range of known laptop computer or tablet computer sizes. The pillow apparatus 1 may have a thickness T1, shown in FIG. 4, which may be about six inches.

In at least one embodiment, a method is provided of inserting a laptop computer or tablet computer 100 into the inner chamber or pocket 8 through the opening 6, and then using the top portion 2 as a pillow to rest a human being's head when the human being is typically lying down.

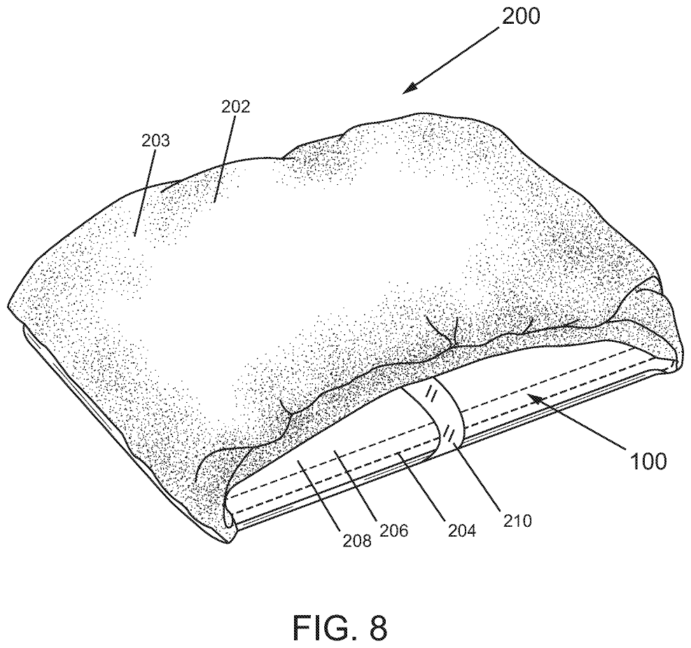

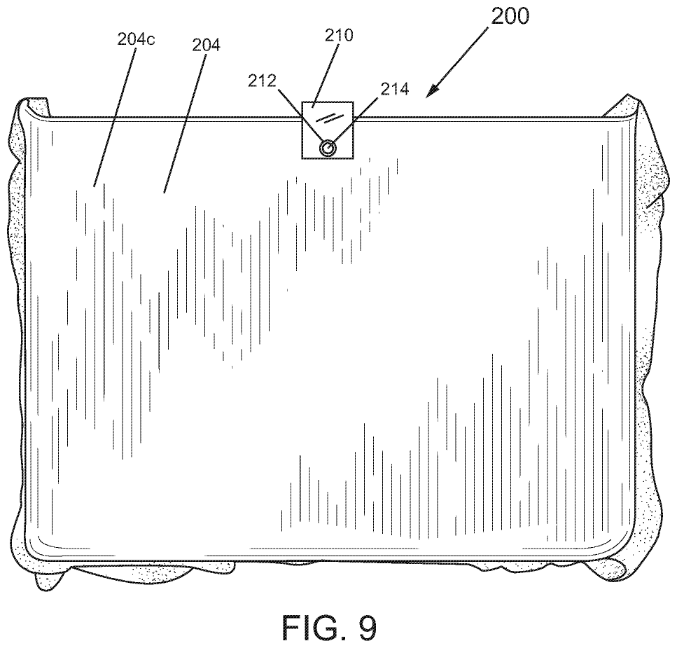

FIG. 8 is a front, top, and left side perspective view of part of another pillow apparatus 200 in accordance with another embodiment of the present invention, with the closed laptop computer or tablet computer 100 shown in broken lines being held inside of the pillow apparatus 200; and FIG. 9 is a bottom elevational view of the pillow apparatus 200 of FIG. 8.

The pillow apparatus 200 may be identical or substantially similar to the pillow apparatus 1 of FIGS. 1-7, except as will be described. The pillow apparatus 200 may include portions 202 and 204, which may be identical or substantially similar to the portions 2 and 4 of the pillow apparatus 1, except as will be described. The pillow apparatus 200 includes strap 210, which has a first end attached to the portion 202 and a second end, which opposed the first end, attached to the portion 204. The first end of the strap 210 may be fixed to the portion 202 opposite a top surface 203, inside of an inner chamber or pocket 208 of the pillow apparatus 200. The pillow apparatus 200 includes an opening 206 between the portions 202 and 204, leading to the inner chamber 208, which may be identical or substantially identical to the opening 6 leading to the inner chamber 8 of the pillow apparatus 1.

The first end of the strap 210 may be fixed to the portion 202, by sewing, or in any other known manner. It is preferred that the first end of the strap 201 be fixed inside of the inner chamber 208 to avoid a person's head contacting the strap 210 when the person's head is resting on the top surface 203 of the portion 202. The second end of the strap 210 may be removably attached to a surface 204c of the portion 204 by an attachment device 212, which is fixed to the strap 210, and which can be removably attached to an attachment device 214, which may be fixed to the surface 204c of the portion 204. Alternatively, the strap 210 may include Velcro (trademarked) or a Velcro (trademarked) hooks and/or loops portion which is configured to removably attach to a Velcro (trademarked) loops and/or hooks portion which is part of or attached to the surface 204c of the portion 204. In other embodiments, the first end of the strap 201 may also be removably attached to the portion 202, through Velcro (trademarked) portions, buttons, clasps or any other known method. The strap 210 can be used when attached as in FIG. 8, to keep the laptop computer or tablet computer 100 in place in the inner chamber 208 or to at least inhibit the laptop computer or tablet computer 100 from falling out of the inner chamber 208.

The pillow apparatus 1, in at least one embodiment, can be used as a backrest, headrest or pillow. The top or outer surface of the material 2a of the portion 2 may be personalized, embroidered, or monogrammed with personal information, professional or college sports team images or information, celebrity images or information.

In at least one embodiment, it is critical that the portion 4 be substantially thinner than the portion 2. For example, the thickness T2, shown in FIG. 2 of the portion 2 should be substantially greater than the thickness T3, shown in FIG. 2 of the portion 4. For example, the thickness T2 of the portion 2 may be four and ⅞ of an inch, while the thickness, T3 of the portion 4 may be ⅛ of an inch, while allowing in this example for a one inch pocket thickness between portions 2 and 4. It is critical in at least one embodiment that the portion 2 be at least ten times thicker for T2 than the thickness T3 of the portion 4. The portion 4 thickness T3 should be thick enough to provide strength so that the portion 4 does not break easily, but thin enough for high elasticity, and for reduced cost. In use a person's head or back will rest on top of material 2a of the portion 2, and the portion 4 will typically be in contact with a surface, which may be a hard surface, such as a bed head board or a back of a couch or chair.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising
a pillow apparatus comprising
a first portion; and
a second portion attached to the first portion;
wherein the first portion includes a cushion;
wherein the second portion is elastic;
wherein the second portion is attached to the first portion so that a pocket is formed between the first portion and the second portion; and
wherein the pillow apparatus is configured to securely encapsulate a computer of a first size within the pocket;
wherein the pillow apparatus is configured to securely encapsulate a Icomputer of a second size larger than the first size within the pocket; and
wherein the pocket is configured to expand so that the pocket is larger when the computer of the second size is within the pocket than when the computer of the first size is within the pocket.

2. The apparatus of claim 1 wherein
the second portion is substantially thinner than the first portion.

3. The apparatus of claim 1 wherein
the first portion is at least ten times thicker than the second portion.

4. The apparatus of claim 1 wherein
the second portion is made entirely of one or more of rayon, nylon, and spandex.

5. The apparatus of claim 1 further comprising
the computer of the first size.

6. The apparatus of claim 5 further comprising
The computer of the second size.

7. The apparatus of claim 1 wherein
the first portion has a surface with personalized indicia on it.

8. A method comprising
inserting a computer of a first size into a pocket of a pillow apparatus;
wherein the pillow apparatus is comprised of a first portion; and a second portion attached to the first portion;
wherein the first portion includes a cushion;
wherein the second portion is elastic;
wherein the second portion is attached to the first portion so that the pocket is formed between the first portion and the second portion; and
wherein the pillow apparatus is configured to securely encapsulate the computer of the first size within the pocket.

9. The method of claim 8 further comprising
taking the computer of the first size out of the pocket; and
inserting a computer of a second size into the pocket, wherein the second size is larger than the first size; and
wherein the pillow apparatus is configured to securely encapsulate the computer of the second size within the pocket.

10. The method of claim 8 wherein
the second portion is substantially thinner than the first portion.

11. The method of claim 8 wherein
the first portion is at least ten times thicker than the second portion.

12. The method of claim 8 wherein
the second portion is made entirely of one or more of rayon, nylon, and spandex.

13. The method of claim 8 further comprising
placing personalized indicia on a top surface of the first portion.

14. The apparatus of claim 1 wherein
the computer of the first size is a laptop computer; and
the computer of the second size is a laptop computer.

15. The apparatus of claim 1 wherein
the computer of the first size is a tablet computer; and
the computer of the second size is a tablet computer.

16. The method of claim 8 wherein
the computer of the first size is a laptop computer.

17. The method of claim 8 wherein
the computer of the first size is a tablet computer.

18. The method of claim 9 wherein
the computer of the first size is a laptop computer; and
the computer of the second size is a laptop computer.

19. The method of claim 9 wherein
the computer of the first size is a tablet computer; and
the computer of the second size is a tablet computer.
